(19) United States
(12) Patent Application Publication
(10) Pub. No.: US 2006/0074991 A1
(43) Pub. Date: Apr. 6, 2006

(54) System and method for generating an amalgamated database

(76) Inventors: Yves A. Lussier, New York, NY (US); Indra Neil Sarkar, New York, NY (US); Michael Cantor, New York, NY (US)

Correspondence Address: BAKER & BOTTS, 30 ROCKEFELLER PLAZA, NEW YORK, NY, 10112, US

(21) Appl. No.: 11/120,715

(22) Filed: May 3, 2005

Related U.S. Application Data
(63) Continuation of application No. PCT/US03/35470, filed on Nov. 6, 2003.
(60) Provisional application No. 60/424,728, filed on Nov. 6, 2002.

(51) Int. Cl. G06F 17/00

(52) U.S. Cl. 707/200

(57) ABSTRACT

A method for creating an amalgamated bioinformatics database from at least a first database and a second database is presented. Concepts are identified in a first field from the records of the first database. A second field from the records of the second database which has data related to the first field is also identified. A first set of concepts is identified by traversing a mediating database using terms associated with the first field and a second set of concepts is also identified by traversing the mediating database using terms associated with the second field. Either the first set of concepts or the second set of concepts, or both, is identified using non-trivial terminological mapping. The set of related concepts in the first set of concepts and the second set of concepts is identified and a record is generated in the amalgamated bioinformatics database.

### FIELD OF THE INVENTION

The present invention relates generally to database architecture and more particularly relates to the construction and use of an amalgamated bioinformatics database from a plurality of related yet disparate databases.

### BACKGROUND OF THE INVENTION

Recent advances in molecular biology have provided increasing amounts of complex data that require novel methods of analysis. For example, the success of the human genome project has increased the need for novel bioinformatics strategies designed to map molecular functional features of gene products to complex phenotypic descriptions, such as those of genetically inherited diseases.

To date, methods for studying complex phenotypes have taken two basic approaches: gene driven, or reverse genetics, which focuses on a specific gene in order to discover the phenotypes they influence; and trait driven, or forward genetics, which focus on phenotypes and looks to find causative genes. Knock out models are the traditional method for proving and analyzing traits influenced by single genes; however, more complex phenotypes affected by multiple, potentially unknown, genetic loci, as well as epistatic relations among them, require more complicated, multivariate methods of analysis.

In addition to the advances being made in molecular biology, there is a wealth of information available to clinicians relating to the different phenotypes associated with diseases. Such phenotypes include the symptoms and treatment of such diseases as well as the causative basis for such diseases.

The respective terminologies that serve the medical and biological sciences communities are of great importance to each individual field. However, links between the two fields are necessary, as medicine increasingly incorporates basic biological science advances into clinical practice, and biologists or bioinformaticians validate their experiments using real patient data. These growing interactions necessitate a standardized method for communicating results between fields.

For many applications it would be desirable to have a system that effectively integrates (i) clinical knowledge, e.g., Unified Medical Language System (UMLS), Quick Medical Reference (QMR); (ii) genetic and genomic knowledge, e.g. OMIM (Online Mendelian Inheritance in Man, OMIM™ McKusick-Nathans Institute for Genetic Medicine, Johns Hopkins University and National Center for Biotechnology Information, National Library of Medicine, 2000.), Gene Ontology (GO); and (iii) reference terminology knowledge, e.g., Systematized Nomenclature of Human and Veterinary Medicine-Clinical Term® (SNOMED CT).

A significant barrier to the integration of heterogeneous phenotypic databases is associated with the varied notational (terminological representation) representations used by various disciplines. For example, among the medical terminologies, the Unified Medical Language System (UMLS) includes terminologies that are generally focused on clinical medicine, so representation of more basic biological terms is often lacking. On the other hand, Gene Ontology (GO) includes a collection of terms specific to genes and proteins from a variety of organisms (Gene Ontology Consortium, 2001, Gen Res. 11:1425-1433) but does not include the range of clinical information provided in UMLS. Thus, there is a need for representation of gene and gene products, such as those from GO, in the UMLS and other clinical databases. While terminologies can be manually or semi-automatically integrated, as illustrated by the meta-terminologies (e.g. Unified Medical Language System), such a process is both time consuming and labor intensive.

A number of methodologies have been used to track putative disease genes by selecting a specific disease and returning a list of genes, supported by scientific evidence, which may be of interest. For example, Locus Link has been used to discover related genes constrained to specific chromosomal regions. Another approach has been to use medical subject headings for exploring pathological relationships between disease etiology and genes annotated in a central database of GO annotations (Periz-Iratxetra et al., 2002, Nat Genet 31:316-319).

Gene expression clustering algorithms have also been applied to higher levels of structures and functions than just genes and proteins. Although phenotypic-genotypic relationships have been investigated with clustering algorithms including molecular histopathogy and multidimensional gene-drug traits, higher level functions and structures, such as those found in clinical observations, remain to be explored (Golub TR et al., 1999 Science 286:531-7; Dan S et al., 2000, Cancer Res. 2000 62:1139-47; Zembutsu H et al., 2002, Cancer Res. 62:518-27).

Clearly, the desire to assess information across multiple information resources with related data is not new. In an article entitled “A Model for Data Integration Systems of Biomedical Data Applied to Online Genetic Databases” by P. Mork et al., AMIA, Nov. 3, 2001, the authors describe a method of searching multiple datasources using a predefined mediating schema. In this work, a fixed set of entities and entity relationships were manually identified and used as a prototype to determine whether a correspondence between two data sources could be established. This mediated schema approach provides a user with a method to query multiple databases and identify paths through the data sources in accordance with the manually defined schema. As noted by the authors, this methodology has certain limitations. For example, some relationships in the source database cannot be expressed in the mediated schema and this information will not be available to the user. Further, the manually defined mediated schema that is described does not provide the ability for an entity defined in the schema to inherit attributes from another entity, or superentity. Again, this presents an opportunity for information to be lost. Accordingly, there remains a need to provide an improved method for integrating and traversing multiple, divergent data sources in which both trivial and rich relationships can be identified and exploited.

To date, the need remains for computer-based high throughput clinical-genomics system that has the potential to identify previously undetected phenotypic-genotypic interactions, as well as contribute to systems-biology discovery of higher biomodules and molecular-clinical systems.

### SUMMARY OF THE INVENTION

It is an object of the present invention to provide a method of integrating multiple datasources into an interoperable database.

It is a further object of the present invention to provide an amalgamated database which relates multiple related, yet not otherwise JOINable database records.

It is another object of the present invention to provide a system including a mediating database which provides common concepts and relationships to associate one database with at least a second database.

It is yet another object of the present invention to provide an enhanced bioinformatics tool in the form of an amalgam database that integrates numerous data sources using a mediating database to identify common concepts and provide a set of inheritable relationships.

In accordance with the present invention, a method for creating an amalgamated bioinformatics database from at least a first database and a second database is presented. Concepts are identified in a first field from the records of the first database. A second field from the records of the second database which has data related to the first field is also identified. A first set of concepts is identified by traversing a mediating database using terms associated with the first field and a second set of concepts is also identified by traversing the mediating database using terms associated with the second field. Either the first set of concepts or the second set of concepts, or both, is identified using non-trivial terminological mapping. The set of related concepts in the first set of concepts and the second set of concepts is identified and a record is generated in the amalgamated bioinformatics database including data from records of the first database, data from records of the second database and the related concepts from the mediating database.

In an alternate embodiment, the amalgamated database record may include relationships inherited from the mediating database. In this alternate embodiment, the identification of related concepts may involve the use of terminological mapping.

In one embodiment, one database takes the form of a database of clinical data and another database takes the form of genomic data. The amalgamated database is then formed with clinical and genomic data related by way of related concepts identified in a mediating database.

Also in accordance with the present invention is a method for creating a knowledge base of relationships between at least one biodata item that is a molecule and at least one other biodata item. The method includes using a first database storing at least one biodata item that is a molecule associated with at least a second biodata item. The second biodata item is contained in a first set. The method also includes using a second database storing a second set of at least one biodata item and any information associated therewith. The first set and the second set are not identical. At least one non-trivial terminological mapping operation is used in connection with a mediating database for identifying an association between a biodata item of the first set with a biodata item of the second set. For each association identified, a relationship is found between the biodata item that is a molecule associated with the second biodata item of the first set of the association and the information associated with the biodata item of the second set of the association. The relationships found are stored in a knowledge base. The term biodata item broadly refers to a piece of information pertaining to the normal or abnormal biology of a cell or organism or clinical data associated therewith.

### BRIEF DESCRIPTION OF THE DRAWING

Further objects, features and advantages of the invention will become apparent from the following detailed description taken in conjunction with the accompanying figures showing illustrative embodiments of the invention, in which

FIG. 1 is a simplified block diagram of a system for generating an amalgamated database from a plurality of databases with relationships not determinable usings a common index or join operation in accordance with the present invention;

FIG. 2 is a flow chart providing the method steps for a first method of generating an amalgamated database from a plurality of databases which do not have a common index or key field;

FIG. 3 is a flow chart further illustrating a method of generating an expanded term set for use in terminological mapping for identifying related concepts among multiple databases;

FIG. 4 is a flow chart further illustrating a method of performing common concept identification in accordance with the present invention;

FIG. 5 is a graph illustrating the proportion of Phenoslim concepts mapped into semantic types of SNOMED, in connection with an example of a terminological mapping process used in the present invention;

FIG. 6 is flow chart illustrating an application of the present invention for generating an amalgamated database record using UMLS as a mediating database between clinical and genetic databases;

FIG. 7 is a pictorial diagram further illustrating the example set forth in FIG. 6;

FIGS. 8A and 8B are tables reflecting results achieved in the practice of the present invention in connection with FIGS. 6 and 7;

FIG. 9 is a block diagram of an exemplary network of databases, in accordance with an example of the present invention; and

FIG. 10 is a graph illustrating precision and recall results obtained in an example of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF PREFERRED EMBODIMENTS

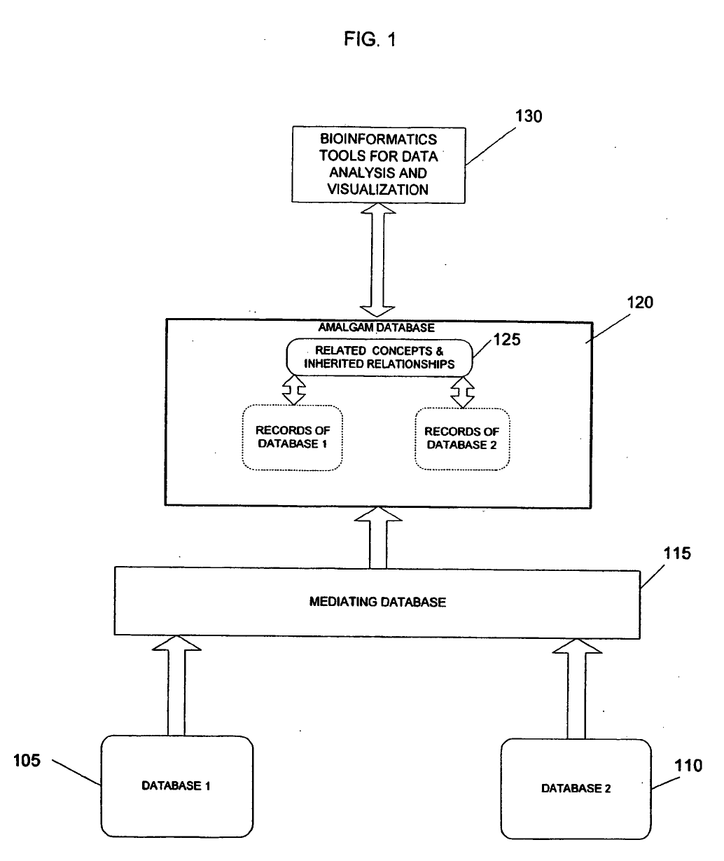

FIG. 1 is a simplified block diagram illustrating the generation of an amalgam database from records of two or more databases using relationships that go beyond the use of a common index or common key. Referring to FIG. 1, two source databases are shown, database 1 105 and database 2 110. It is assumed that database 1 105 and database 2 110 contain information which is somewhat related but do not share a common key or index field which would enable a direct JOIN operation to be performed to allow interoperability between the records of the two databases. An example of two such databases would include Quick Medical Reference™, or QMR, which is a clinical support database of diseases, signs and symptoms from First Data Bank, Inc. of Bruno, Calif., and Online Mendelian Inheritance in Man (OMIM), available from the National Center for Biotechnology Information (http://www.ncbi.nlm.nih.gov/omim/). The OMIM database provides, inter alia, genetic and genomic data and text associated with inheritable diseases.

Clearly there is a degree of relatedness between the clinical information related to various diseases in QMR and the genetic information related to inheritable diseases in OMIM. However, the records of these databases do not share a common key and cannot be JOINed using traditional database techniques. In FIG. 1, two source databases are shown being coupled to a mediating database, but it will be appreciated that the present invention is extendable to associate a greater number of databases.

The present application uses the terms bioobject and bioentity in connection with the present invention. In general, these terms refer to a biological object or concept about which information is collected, such as a disease or a genetic locus. In addition, the terms bioattribute and biodata item may also be used in the present disclosure. These terms generally refer to a piece of information pertaining to the normal or abnormal biology of a cell or organism. This can include a wide range of information. A non-exhaustive list of such biodata items can include a molecule, such as a nucleic acid molecule, such as a DNA or a RNA molecule, a gene or a portion thereof, an allele, an EST, a cDNA, a DNA, a mRNA or a portion thereof; a mutation, a chromosome rearrangement, other chromosomal abnormalities including addition or loss of one or more chromosomes; a protein, a peptide, an epitope, an antibody, a carbohydrate, a lipid, a cofactor, or any other complex molecule; a molecular property, such as single-stranded, enantiomer, antisense, coding strand, denatured, conjugated to a second molecule; a subcellular organelle, a cell, a tissue, an organ, an organ system, an organism, a non-human animal or a human. The term biodata item can also refer to phenotypes as well as clinical manifestations of disease which can be exhibited by a human or a non-human organism.

Database 1 105 and database 2 110 are coupled to a mediating database 115. Mediating database 115 can be a single database or a plurality of interoperable databases. The meditating database 115 is used to identify related concepts between database 1 105 and database 2 110 such that data in these two distinct databases can be rendered interoperable in the resulting amalgam database 120. The mediating database 115 generally provides an overarching ontology from which concepts can be identified from at least one datafield in each of database 1 and database 2. For example, SNOMED CT can be used as a mediating database between QMR and OMIM. Preferably, terminological mapping is applied to at least one of database 1 or database 2 and the mediating database 115 to identify related concepts. In addition to an overarching ontology from which related concepts can be identified, the mediating database 115 can also provide relationships associated with the related concepts.

The relationships of the related concepts in the mediating database 115 can be inherited into the amalgam database 120 such that a new family of relationships can emerge between the records of database 1 and those of database 2 110. This is illustrated in sub-box 125 which pictorially illustrates the newly identified set of related concepts and inherited relationships establishing an interoperable link between at least a set of records in database 1 105 and database 2 110. From the set of related concepts and inherited relationships, additional inferential relationships, not expressly stated in any of database 1 105, database 2 110 or the mediating database 115, can also be established within the amalgam database 120. Thus, the mediating database 115 is capable of operating more than as a mere cross index or foreign key between the first database 1 105 and database 2 110.

Relationships among the records of database 1 and database 2 can be explored by recursive mapping. For example all ancestors of a concept identified from database 1 105 can be found in the mediating database 115 by navigation the relevant “parent-child” relationships. In a like manner, parent-child relationships of the concept can also be identified in database 2 110. Through an evaluation of these ancestral relationships, a set of overlapping relationships it may be uncovered. Thus, a concept of database 1 105 may be associated with an ancestry relationship with a record of database 2, even though the mediating database may not contain a direct relationship linking the concepts of database 1 to database 2 with only one “parent-child” relationship.

Databases such as UMLS and SNOMED express a wide variety of relationship types. For example, in UMLS, there are currently eleven types of relationships that exist in the Metathesaurus. These relationships include:
Broader (RB)—has a broader relationship.
Narrower (RN)—has a narrower relationship.
Other related (RO)—has relationship other than synonymous, narrower, or broader.
Like (RL)—the two concepts are similar or “alike”.
RQ—unspecified source asserted relatedness, possibly synonymous.
SY—source asserted synonymy.
Parent (PAR)—has parent relationship in a Metathesaurus source vocabulary.
Child (CHD)—has child relationship in a Metathesaurus source vocabulary.
Sibling (SIB)—has sibling relationship in a Metathesaurus source vocabulary.
AQ—is an allowed qualifier for a concept in a Metathesaurus source vocabulary.
QB—can be qualified by a concept in a Metathesaurus source vocabulary.for SNOMED CT:

SNOMED has a vast collection of relationships as well. A list of the relationships in SNOMED is available in SNOMED Clinical Terms® Technical Implementation Guide (2002-07-26), which is hereby incorporated by reference in its entirety. Examples of valid relationships in SNOMED are set forth in the table set forth below.

| RELATIONSHIP NAME | IDENTIFIER | COMMENTS |
|---|---|---|
| Access | 260507000 | |
| Access instrument | 370127007 | New in SNOMED CT second |
| | | release. |
| Approach | 260669005 | |
| Associated etiologic | 363715002 | |
| finding | | |
| Associated finding | 246090004 | |
| Associated function | 116683001 | |
| Associated morphology | 116676008 | |
| Causative agent | 246075003 | |
| Communication with | 263535000 | |
| wound | | |
| Component | 246093002 | New in SNOMED CT second |
| | | release. |
| Course | 260908002 | |
| Direct device | 363699004 | |
| Direct morphology | 363700003 | |
| Direct substance | 363701004 | |
| Episodicity | 246456000 | |
| Finding site | 363698007 | |
| Has active ingredient | 127489000 | |
| Has definitional | 363705008 | |
| manifestation | | |
| Has focus | 363702006 | |
| Has intent | 363703001 | |
| Has interpretation | 363713009 | New in SNOMED CT second |
| | | release. |
| Has specimen | 116686009 | New in SNOMED CT second |
| | | release. |
| Indirect device | 363710007 | New in SNOMED CT second |
| | | release. |
| Indirect morphology | 363709002 | New in SNOMED CT second |
| | | release. |
| Interprets | 363714003 | |
| Laterality | 272741003 | |
| Location | 246267002 | |
| Measures | 367346004 | |
| Method | 260686004 | |
| Occurrence | 246454002 | |
| Onset | 246100006 | |
| Part of | 123005000 | |
| Pathological process | 370135005 | |
| Priority | 260870009 | |
| Procedure site | 363704007 | |
| Recipient category | 370131001 | New in SNOMED CT second |
| | | release. |
| Revision status | 246513007 | |
| Severity | 246112005 | |
| Stage | 258214002 | |
| Subject of information | 131195008 | New in SNOMED CT second |
| | | release. |
| Temporally follows | 363708005 | |
| Using | 261583007 | |

The use of relationships, such as those noted above, can be further understood by reference to the following example. As described above, QMR and OMIM are two semi-structured databases that do not have a common key and were not interoperable via classical database methods. These two databases have been amalgamated using SNOMED as the mediating database 115 to provide an overarching terminology from the terms in database 1 (QMR) and the terms from database 2 (OMIM). The mediating database 115 provides related concepts and a coding reference with respect thereto to facilitate a link between records of database 1 with records of database 2 to form an amalgamated database 120. By identifying related concepts as well as by inheriting relationships from the related concepts, an expanded knowledge base is established.

For example, from QMR, it is known that hemophilia B is associated with “Bone X-Ray Osteolytic Lesion.” From OMIM, it is known that the gene believed to be associated with hemophilia B is located in the region “Xq27.1-q27.2.” Even if the two databases could be associated with a simple “join” operation, this form of trivial merger of databases would relate the “Bone X-Ray Osteolytic Lesion” as a phenotype (trait) of the gene located in region “Xq27.1-q27.2”, but no more. The amalgam database of the present invention provides a more profound merger wherein new properties emerge from the process, in addition to the previously described relationship (e.g., “Bone X-Ray Osteolytic Lesion” is a phenotype of the gene located in region Xq27.1-q27.2). In this example, the amalgam database also contains additional classification references from SNOMED for “hemophilia B” in SNOMED, as shown in Table 1, set forth below.

TABLE 1

| Disease | Relationship | Higher level Disease (or class) |
|---|---|---|
| Hemophilia B | Is a (attribute) | X-linked hereditary disease (disorder) |
| (disorder) | | |
| Hemophilia B | Is a (attribute) | Hemophilia (disorder) |
| (disorder) | | |
| Hemophilia B | Is a (attribute) | Hereditary disorder of hematologic |
| (disorder) | | system (disorder) |
| Hemophilia B | Finding site | Hematological system (body structure) |
| (disorder) | (attribute) | |

From this expanded set of relationships, the amalgam database 120 can be used to infer that an X-linked hereditary disease has a “Bone X-Ray Osteolytic Lesion” which is a phenotype of the gene located in region Xq27.1-q27.2. This is an example of new knowledge that was not expressed in either SNOMED, QMR, or in OMIM.

Additional relationships from the source databases can also be used to discover buried relationships between the database records. For example, QMR includes relationships such as “disease causes”; “disease predisposes to”; disease is the systemic component of”; “disease is predisposed to by”; and “disease is preceded by.” These relationships can be used in a like manner to the example set forth above to identify new relationships between the source databases. It will be appreciated that a database such as QMR could be used in the context of the present invention as a mediating database to relate a first database of pediatric diseases with a second database of geriatric diseases to identify heretofore unknown causal and precedential relationships.

Referring to FIG. 1, it is preferable to provide a set of bioinformatics tools 130 to allow a user to access and mine the data of the amalgam database 120. The bioinformatics tools preferably include a graphical user interface (GUI) which allows a user to enter and modify search terms and provide various tools for analyzing the data. In the case of a clinical-genomic amalgam database, tools such as GeneCluster may be provided to perform statistical analysis with respect to heirarchical clustering of gene-trait relationship. GeneCluster (and now GeneCluster 2) software is available from the Whitehead Institute, Center for Genome Research. Visualization tools, such as Tree View and ClusterView (a feature of GeneCluster 2), may then be used to display the GeneCluster results in graphical form to the user. Other graphical tools to present a mapping of relationships and data in the amalgam database are contemplated as well. TreeView software is described in the article “An application to display Phylogenic Trees on Personal Computers,” by R.D.M. Page, Computer Applications in the Biosciences 12:357-358, 1996 and is available from R. Page at the Institute of Biomedical and Life Sciences, University of Glasgow, Scotland.

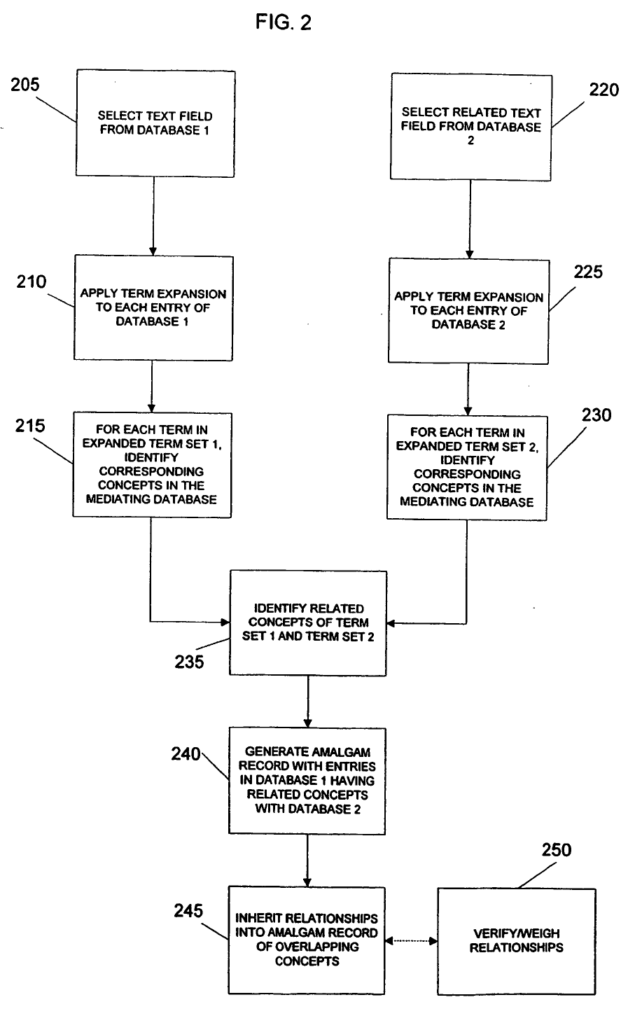

FIG. 2 is a flow chart illustrating a process for generating an amalgam database 120 in accordance with the present invention. In step 205 a user selects a text field from database 1 105 which contains text-based information of interest. For example, database 1 may include a TERM column, in which semi-structured or unstructured text is used to describe the database entries. In the context of the present invention, semi-structured text is that which follows a set of rules with respect to vocabulary, order and syntax. Unstructured text does not require compliance with any normalization criteria. An example of unstructured text wold include abstracts of articles. Tables 2A, 2B and 2C illustrate data from the QMR database which includes a definitions table, a relationships table and a meta-data table respectively. The last column in Table 2A, the definition column, is an example of semi-structured text which would be a suitable candidate for selection in step 205.

TABLE 2A
Definitions Metadata

| Definition | Metadata | |
|---|---|---|
| Identifier | Identifier | Definition |
| 1412 | 10 | CHRISTMAS DISEASE |
| 865 | 20 | BONE XRAY OSTEOLYTIC |
| | | LESION <S> |
| 2845 | 20 | HEMOPHILIA FAMILY HX |
| 1532 | 20 | CONJUNCTIVA |
| | | HEMORRHAGE <S> |
| | | LARGE |

TABLE 2B
Relationships

| Attribute | Value |
|---|---|
| 1412 | 865 |
| 1412 | 2845 |
| 1412 | 1532 |

TABLE 2C

| Metadata | |
|---|---|
| Identifier | Term |
| 10 | Disease |
| 20 | Findings |

Table 3 illustrates the data from an exemplary record from the OMIM gene map database. Table 3 includes a number of columns with text fields that could be selected. The column labeled “disorder” has the highest degree of relatedness to the definition column in table 2A and would likely be the column selected for terminological mapping. The selection of the appropriate columns to be correlated can be performed manually or by an automated language processing operation which provides a measure of similarity in the terms used in the various database fields.

TABLE 3
An example of a record from the OMIM Gene map

| Location | Symbol | Title | MIM # | Disorder | Comments | Method | Mouse |
|---|---|---|---|---|---|---|---|
| Xq27.1-q27.2 | F9, HEMB | Coagulation | 306900 | Hemophil- | distal to | REa, A, | X(Cf9) |
| | | factor IX | | ia B (3); | HPRT; | Fd, D, | |
| | | (plasma | | Warfarin | proximal part | X/A, RE | |
| | | thromboplas- | | sensitivity | of Xq27 | | |
| | | tic | | (3) | | | |
| | | component) | | | | | |

Upon comparison of Tables 2A, 2B and 2C with Table 3, it becomes apparent that these databases of interest are not presented in a compatible format which would lend themselves to convergence. Accordingly, to increase the interoperability of the source databases, it can be desirable to transform the source databases and mediating database into a common generic model.

The three table format of the QMR database illustrated in Tables 2A, 2B and 2C, provide one possible prototype for a generic model. If the format of one of the databases is selected as the generic model, only the second source database needs to be transformed in order to generate the amalgam database. Thus, for the example set forth above in which the source databases include QMR and OMIM, a generic common format consisting of three database tables can be employed: a metadata table, a schema of relationships pairs and a code definition table. QMR Tables 2A, 2B and 2C already conform to this particular generic format. In contrast, the OMIM records, as illustrated in Table 3, require transformations to conform to the generic model and generate OMIM Tables 4A, 4B, and 4C, set forth below.

TABLE 4A
Definitions

| Definition | Metadata | |
|---|---|---|
| Identifier | Identifier | Definition |
| 1 | 100 | Xq27.1-q27.2 |
| 2 | 200 | F9, HEMB |
| 3 | 300 | Coagulation factor IX |
| | | (plasma thromboplastic |
| | | component) |
| 4 | 400 | 306900 |
| 5 | 500 | Hemophilia B (3) |
| 5 | 500 | Warfarin sensitivity (3) |
| 6 | 600 | distal to HPRT; |
| | | proximal part of Xq27 |
| 7 | 700 | REa, A, Fd, D, X/A, RE |
| 8 | 800 | X(Cf9) |

TABLE 4B
Relationships

| Attribute | Value |
|---|---|
| 5 | 1 |
| 5 | 2 |
| 5 | 3 |
| 5 | 4 |
| 5 | 6 |
| 5 | 7 |
| 5 | 8 |

TABLE 4C
Metadata

| Metadata | |
|---|---|
| Identifier | Term |
| 100 | Location |
| 200 | Symbol |
| 300 | Title |
| 400 | MIM1 code |
| 500 | Disorder |
| 600 | Comments |
| 700 | Methods |
| 800 | Mouse |

The database table of Table 3 is transformed into the generic model of Tables 4A, 4B, and 4C as follows. To create a new definition Table 4A, the terms found in a cell of Table 3 are inserted into a distinct row of the definition table and a unique definition identifier for a term is created. If a term is repeated in Table 3, it is assigned the same unique identifier in Table 4A. In addition, where two distinct terms are used for the same concept of disorder in the same cell of Table 3, the terms have been parsed into two distinct rows with the same identifier in the definition table (synonyms in Table 4A). The identifiers created in Table 4A should be unique and therefore distinct from those already used in the source database tables.

The following steps are performed to generate the meta-data of Table 4C. The columns in Table 3 each have a meaning (meta-data) which is represented as a distinct code in column 2 of Table 4A. Table 4C contains a definition for every column of Table 2C (called meta-data) and a unique identifier for each definition used to define the origin of each row of Table 3.

To create the relationship table set forth in Table 4B, a “pivot” operation is applied to each row of Table 3. Since in the present example it is an objective to interoperate QMR and OMIM tables by relating their disease and disorder relationships, the data pivoted around the Disorder column (5^{th} column) of Table 3. This means that each row of the relationships Table 4B will contain a relation between the specific disorder of that row and one of the element of one of the other cells of that row. For example, the first row of Table 4B contains the relationship Attribute=5, Value=1, where the definition table indicates that value 5=“Hemophilia B” AND “Warfarin sensitivity” (the two terms of the disorder column of the first row of table 3), while 1=“Xq27.1-q27.2” the “genetic location” of that disorder found in the first cell of the first column of Table 2C. The second row of Table 4B pertains to the relationship of the second column of the same row of Table 3 associated with the same disorder, and so on. If Table 2C contained more than one row, the same pivot operation would be conducted on the rows that would follow. This would complete the transformation into the generic model.

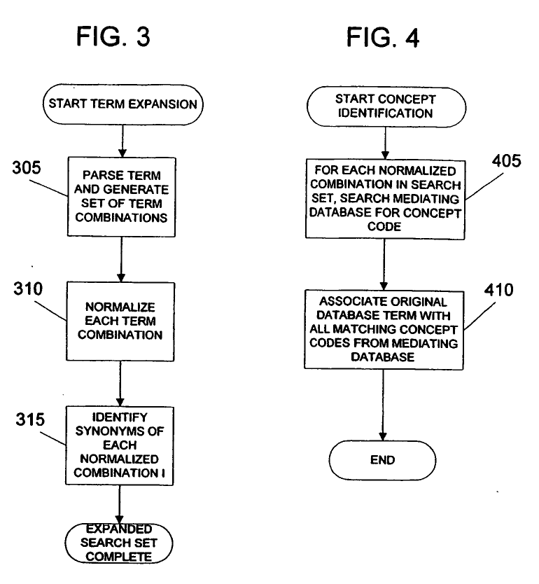

Returning to FIG. 2, the text from the selected field for the current record of database 1 is preferably subjected to one or more term expansion operations (step 210). One such term expansion algorithm is described in connection with FIG. 3 and will be described more fully below. Term expansion results in the generation of an expanded term set related to the text of the selected field from the record in database 1.

In step 215, the terms in the expanded term set from step 210 are used to identify a first set of concepts in the mediating database 115. As further illustrated in FIG. 4, concepts can be identified in the mediating database by finding matches to the terms in the expanded term set with those in the mediating database and associating a concept identifier in the mediating database with the matching terms. Steps 210 and 215 can be viewed as terminological mapping which will return a “match” for similar terms which do not necessarily present an exact match to the term in the original database. For example, SNOMED includes a many to one mapping of terms to SNOMED identifier codes, as illustrated in Table 5 set forth below.

TABLE 5
SNOMED 3

| Original SNOMED Term | Transformed by Norm | SNOMED code |
|---|---|---|
| Hemophilia B, NOS | b hemophilia | DC63160 |
| Congenital factor IX | congenital disorder factor ix | DC63160 |
| disorder | | |
| Christmas Disease, NOS | christmas disease | DC63160 |
| Sex-linked factor IX | deficiency disease factor ix | DC63160 |
| deficiency disease | sex-linked | |
| PTC deficiency disease | deficiency disease ptc | DC63160 |

In the most generalized case, database 2 110 (FIG. 1) does not contain direct references to the concept code identifiers of the mediating database and cannot be directly joined to the mediating database 115 through traditional database 115 operations. In this case, steps 220, 225 and 230 are performed in order to map terms of database 2 110 to the concepts of the mediating database 115. Steps 220, 225 and 230 are similar to those described above with respect to steps 205, 210 and 215, respectively. In those cases where database 2 110 includes an association with the concepts of the mediating database 115, the process of FIG. 2 can advance to step 235.

Following steps 215 and 230, at least a subset of the terms of database 1 105 and database 2 110 have been mapped to a set of one or more concept identifiers of the mediating database 115 (FIG. 4, step 405). From these individual mappings, those records of database 1 having a related concept identifier with records of database 2 are identified and those records are associated by the mediating database concept identifier in step 235 (FIG. 4, step 410). A table can be generated in the amalgam database in step 240 which is indexed or keyed by the concept identifier from the mediating database 115. From the set of related concepts identified in step 240, the relationships in the mediating database associated with those concepts can also be inherited into a table in the amalgam database 120 (step 245).

Optionally, additional processing can be applied to verify or assign weights to the term-concept relationships that are derived in the amalgam database (step 250). For example, term-concept relationship tuples can be searched in a database of articles related to the subject matter, such as Medline, to determine if there is substantial co-occurrence of the term-concept pair in published works. Term-concept pairs which do not have a sufficient co-occurrence ranking can be dropped or given a lower weighting. It will be appreciated that co-occurrence analysis is but one method that can be used to evaluate the strength of the concepts and relationships in the amalgam database 120.

The term expansion operation of steps 210 and 225 can take on a number of forms. FIG. 3 is a flow chart illustrating the steps used in one exemplary algorithm for generating an expanded term set from the terms presented in the source databases. The terms identified in the source databases can include structured or non-structured text. In the case of non-structured text, a natural language preprocessing step can be applied to identify search terms for expansion. For multiple word search terms, the search term is parsed into single word components and combinations of these components are identified. For example, if the search term identified in database 1 includes a three word phrase, A-B-C, this would be parsed into the components A, B, C and combinations ABC, AB, AC, BC, A, B, and C would be established.

The identified combinations are preferably subjected to a normalization operation (step 310). Normalization is a process by which the terms are transformed into a common format. For example, terms can be placed in an order depending on the part of speech (i.e., verb, noun, adjective, etc.), capitalization can be removed, plural forms replaced with non-plural forms and the like. Known lexical tools such as NORM, which is a component available in UMLS, can be used to normalize the terms for the expanded term set. Tables 6 and 7 set forth below illustrate an example of the application of NORM to a term in QMR and OMIM, respectively.

TABLE 6
QMR

| Original QMR term for | |
|---|---|
| a disease in Table 6 | Transformed by norm |
| Christmas | disease christmas |
| Disease | |

TABLE 7
OMIM

| Original OMIM term for a | Transformed by |
|---|---|
| disorder in Table 10 | norm |
| Hemophilia B | b hemophilia |

The normalized terms of the expanded term set are then applied to the mediating database 115 to identify synonyms of the terms and related concepts (step 315). For example, SNOMED with a vast ontology of biomedical terms can be used to identify of terms identified from the QMR and OMIM databases. The completed expanded term set then includes the normalized combinations of the original term as well as the identified synonyms thereof. This expanded term set can then be used in a terminological mapping operation to identify related concepts in the meditating database 115. It will be appreciated that this form of terminological mapping achieves non-trivial terminological mapping, i.e., other than exact matches, from the original term in the source databases 105, 110 to the terms in the mediating database 115.

Table 8 set forth below illustrates the non-exact matching that can be achieved. The first column of Table 8 shows the different synonyms of Hemophilia B in SNOMED. It is noteworthy that there is no exact match of any of the normalized text strings of the first column of Table 8 and the text strings of the QMR Table 4B and the OMIM Table 7. Thus, the text strings of these tables would not be suitable for use as a key to interoperate OMIM and QMR using classical database technologies.

TABLE 8
SNOMED 3

| Original SNOMED Term | Transformed by Norm | SNOMED code |
|---|---|---|
| Hemophilia B, NOS | b hemophilia | DC63160 |
| Congenital factor IX | congenital disorder factor ix | DC63160 |
| disorder | | |
| Christmas Disease, NOS | christmas disease | DC63160 |
| Sex-linked factor IX | deficiency disease factor ix | DC63160 |
| deficiency disease | sex-linked | |
| PTC deficiency disease | deficiency disease ptc | DC63160 |

The second column of Table 8 shows the transformed text strings using Norm. The term “b hemophilia” from the second column of the QMR Table 5 maps to the same term of the second column and first row of the normalized SNOMED terms of Table 8. Similarly, the term “Christmas disease” of the second column of Table 6 maps to the same term of the second column and third row of the normalized SNOMED terms in Table 8. From the third column of the SNOMED Table 8, it can be observed that these SNOMED terms come from the same SNOMED Concept Code DC63160. From the common concept code it can be established that the QMR disease “Christmas Disease” is the same concept as the OMIM disorder “Hemophilia B”. This association can be used to produce a relation between keys to automatically map between QMR and OMIM since “Christmas Disease” is represented in QMR with the unique QMR identifier “1412” (Table 6, Row 2A) and Hemophilia B is represented in OMIM with the unique OMIM identifier “5” (Table 4A, column 1, row 5). Mapping between other QMR diseases and OMIM disorders can proceeds in a like manner.

The use of Norm is but one example and it will be appreciated a variety of mapping techniques could be used to map OMIM to SNOMED and QMR to SNOMED. Other forms of terminological mapping include exact lexical match, MMTx, which is a metamap tool available in UMLS, and lexico-semantic mapping. Preferably, a hybrid combination of these strategies may be employed. For example, an incremental approach can be used in which exact string matching is applied, followed by Norm or Norm supplemented with lexico-semantic information to match unmatched terms, followed by MMTx, such as with “strict” matching criteria. Alternatively, a number of approaches can be applied to a particular matching problem and the most successful approach for a given set of terms selected.

It is significant to note that the use of non-trivial terminological mapping may result in an erroneous identification of concepts as being related. This result is expected. As the intent is to expand the set of related concepts, a slight reduction in precision is tolerable in order to achieve this objective. Additional automated or manual screening is expected to be able to quickly identify erroneously identified related concepts.

### EXAMPLE 1

### Terminological Mapping

An automated multi-strategy mapping method for high throughput combination and analysis of phenotypic data deriving from heterogeneous databases with high accuracy has been developed. The method includes a mapping strategy that provides for the assessment of the qualitative discrepancies of phenotypic information between a clinical terminology and a phenotypic terminology.

The method made use of Phenoslim, SNOMED and UMLS. Phenoslim is a particular subset of the phenotype vocabularies developed by Mouse Genome Database (MGD) that is used by the allele and phenotype interface of MGD as a phenotypic query mechanism over the indexed genetic, genomic and biological data of the mouse. The 2003 version of PS containing 100 distinct concepts was used in the current study.

As noted above, the SNOMED CT terminology (version 2003) is a comprehensive clinical ontology that contains about 344,549 distinct concepts and 913,697 descriptions, which are test string variants for a concept. SNOMED-CT satisfies the criteria of controlled computable terminologies and, in addition, provides an extensive semantic network between concepts, supporting polyhiearchy and partonomy as directed acyclic graphs (DAGs) and twenty additional types of relationships. It also contains a formal description of “roles” (valid semantic relationships in the network) for certain semantic classes. SNOMED CT has been licensed by the National Library of Medicine for perpetual public use as of 2004 and will likely be integrated to UMLS.

UMLS is created and maintained by the National Library of Medicine. The 2003-version of the UMLS consisting of about 800,000 unique concepts and relationships taken from over 60 diverse terminologies was used in this example. In addition, UMLS includes a curated semantic network of about 120 semantic types overlying the terminological network. Moreover, at the time of this example, UMLS contained an older version of SNOMED (SNOMED 3.5, 1998) that houses about half the number of concepts and descriptions of the current version of SNOMED-CT. The relationships found in the source terminologies in UMLS are not curated. Thus transformations over the unconstrained UMLS network are required to obtain a DAG and to control convoluted terminological cycles.

As set forth above, Norm is a lexical tool available from the UMLS. As its name implies, Norm converts text strings into a normalized form, removing punctuation, capitalization, stop words, and genitive markers. Following the normalization process, the remaining words are sorted in alphabetical order.

The applications and scripts pertaining to implementation of the methods for this example were written in Perl and SQL, although other computer languages could be used without limitation. The database software used was IBM DB2 for workgroup, version 7. The Norm component of the UMLS Lexical Tools was obtained from the National Library of Medicine in 2003. Applications were run on a Dual-processor SUN UltraSparc III V880 under the SunOS 5.8 operating system.

Phenoslim was mapped to SNOMED CT to develop an architecture that integrates lexical, terminological/conceptual and semantic approaches to methodically take advantage of pre-coordination and post-coordination mechanisms. The specific method steps used sequentially were a) decomposition of Phenoslim concepts in components, b) normalization of Phenoslim and SNOMED CT, c) mapping of PS components to SNOMED CT, d) conceptual processing, and e) semantic processing. Steps a), b) and c) are “term processing” steps that have been separated for clarity. Retired concepts and descriptions of SNOMED were not used in the study, though they are present in the SNOMED files. The method steps a-e used in this example are described more fully below.

Step a—Decomposition of Phenoslim concepts in components. Each Phenoslim concept is represented by one unique text string consisting of several words. Every combination of word was generated for each unique text string (including the full string) and mapped back to the original concept. A terminological component (TC) is a string of text consisting of one of these combinations.

Step b—Normalization of Phenoslim and SNOMED CT. Each terminological component of Phenoslim and each term associated with a SNOMED CT concept (SNOMED descriptions) was normalized using Norm (ref. material section).

Step c—Mapping of PS components to SNOMED CT. Each normalized TC was mapped against each normalized SNOMED description using the DB2 database.

Step d—Conceptual Processing. This process simplifies the output of the mapping methods. The Conceptual Processor is a database method that identifies all distinct pairs of conceptual identifiers of Phenoslim and SNOMED CT (PS-CT Pairs) that have been mapped by the previous terminological processes.

Step e—Semantic Processing. The semantic processing consists of two successive subprocesses: (i) semantic inclusion criteria, and (ii) subsumption. For inclusion criteria, mapped SNOMED CT concepts were sorted according to the criteria “that they must be a descendant of at least one semantic class shown in Table 9”. This process eliminates erroneous pairs arising from homonymy of terms due to the presence of a variety of semantic classes in SNOMED that are irrelevant to phenotypes. An inclusion criteria was chosen since valid concepts may inherit multiple semantic classes. The list of SNOMED codes related PS concept was further reduced by subsumption with the relationships found in the relationship table of SNOMED as follows: two ancestor-descendant tables (one from the “is-a” relationship of the relationship table of SNOMED CT and another one from the partonomy relationships “is part of”) were constructed. Each network of SNOMED CT concepts paired to a unique PS concept was then recursively simplified by removing “is-a” ancestors that subsume other concepts of the network concept, based on the hypothesis that most specific match is also the most relevant. The same procedure was repeated for the “is part of” relationship. Further, additional relationships of the disease and finding categories were explored in the relationship table and the concept related to a disease or finding was considered subsumed and then removed (within the scope of SNOMED concepts paired to the same PS concept). The remaining set of PS-CT pairs were considered valid for the evaluation.

TABLE 9
Included Semantic Classes of SNOMED CT

| | SNOMED CT Concept |
|---|---|
| Concept Identifier | Name |
| 257728006 | Anatomical Concepts |
| 118956008 | Morphologic Abnormality |
| 64572001 | Disease (disorder) |
| 363788007 | Clinical history/examination |
| 246188002 | Finding |
| 246464006 | Functions |
| 105590001 | Substance |
| 243796009 | Context-dependent categories |
| 246061005 | Attribute |
| 254291000 | Staging and scales |
| 71388002 | Procedure |
| 362981000 | Qualifier value |

The mapping methods previously described produce from zero to multiple putative SNOMED concepts for every Phenoslim concept. Every group of distinct SNOMED concepts related to a unique PS concept was further assessed according to the following criteria: (i) classification—the SNOMED CT concepts are valid classifier or descriptor of part of the Phenoslim concept (Good/Poor), (ii) identity—the meaning of the SNOMED CT concept is exactly the same as that of the Phenoslim concept, (iii) completeness of representation of the meaning by SNOMED concepts, (iv) redundancy of representation of SNOMED concepts, (v) presence of erroneous matches. In addition, SNOMED CT was searched to find an identical identifier or a class that could represent every PS concept that was not paired using the automated method. The efficacy of the mapping method using precision and recall was measured.

Using the term expansion and mapping methods described herein, every combination of words contained in each term associated with the 100 concepts of Phenoslim were computed yielding 4,016 terminological components. These components were processed in Norm by every possible mapping with a SNOMED—CT description calculated in DB2 in less than 2 minutes (about 3,5 billion possible pairs). 4,842 distinct terminological pairs were found. The conceptual processing reduced this number to 1,387 pairs between Phenoslim and SNOMED CT concepts. The final semantic processing provided the final set consisting of 740 distinct pairs (426 pairs did not meet the semantic inclusion criteria and 221 pairs were removed by subsumption).

Three Phenoslim concepts were not mapped, one of which could not be mapped or classified in SNOMED CT (the only true negative map). Referring to Table 10, set forth below, seventy-nine (79) PS concepts were fully mapped to a valid composition of SNOMED concepts, fifteen (15) of which also contained one erroneous and superfluous SNOMED code. Eighteen (18) PS concepts were incompletely mapped, two of which also contained an erroneous and superfluous concept. Overall, eighteen (18) concepts were also redundantly mapped (not shown in the table)—having more than one representation of the same concept or an overlapping group of concepts.

TABLE 10
Evaluation of the Quality of the Mapping between each Group
of SNOMED Concepts associated to each Concept of Phenoslim

| | | Validity of the Mapping to a | |
|---|---|---|---|
| | | Cluster of SNOMED Concepts | |
| | | Valid | False |
| Phenoslim's | Complete Map | 64 | 15 |
| Concepts | (identity and | | |
| Mapped by | classification) | | |
| the present | Incomplete Map | 18 | 2 |
| methods | (classification) | | |

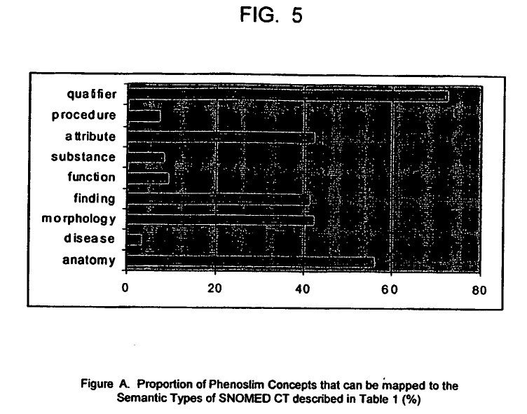

FIG. 5 shows the proportion of Phenoslim concepts that can be classified to the semantic types of SNOMED. On average each concept is mapped to 2.9 semantic classes.

Norm and the conceptual processing performed together at a precision of 11% (TP=64+18, FP=15+426+221). The precision of terminological classification accuracy of the methods described herein is 98% (TP=725, FP=15). The precision and recall of the present methods to classify Phenoslim concepts in SNOMED CT are 85% and 98%, respectively (TP=64+18, FP=15, FN=2); while the accuracy scores are 67% (precision) and 97% (recall) for the present methods used to map the full meaning in SNOMED (TP=64, FP=15+18, FN=2).

TABLE 11
Examples of Problematic Mappings

| Mapping | Examples | |
|---|---|---|
| Problem | Phenoslim | SNOMED |
| (i) erroneous | “ . . . premature | “immature” + |
| mapping | death” | “death” |
| (ii) partial | “Hematology . . . ” | Partially mapped |
| mapping | | missing |
| | | “hematological |
| | | system” |
| (iii) relevant | “ . . . postnatal | “postneonatal death” |
| mappings omitted | lethality”” | |
| by M³ | | |
| (iv) redundancy | “coat: hair texture | “hair texture (body |
| | defects” | structure)”, “Texture |
| | | of hair (observable |
| | | entity), Hair texture, |
| | | function (observable |
| | | entity) |
| (v) ambiguity | “renal system . . . ”, | Including the |
| | | bladder, the |
| | | urogenital? |
| (vi) inconsistency | “neurological/behavioral: . . . movement | |
| | anomalies” | |
| | “neurological/behavioral: . . . nociception | |
| | abnormalities” | |
| (vii) Not in | “Coat . . . ”, | — |
| SNOMED | “Vibrissae . . . ” | |
| (viii) Context/ | “Embryonic . . . ” | “Fetal . . . ” + |
| Representation | | “Embryonic . . . ” |
| Scope | | |

Table 11 illustrates examples of mapping problems encountered in the context of Example 1. Erroneous mapping occurred due in part to slightly different meanings of related concepts which were taken out of their context. For example, the concepts “human fetus” (>8 wks gestation) and “human embryo” (<8 wks) are subsumed by the concept “mammalian embryo” (vertebrate at any stage of development prior to birth). In SNOMED, the parent of the terms fetus and embryo is “developmental body structure” which is the one desired for mapping this mammalian concept. In addition, SNOMED is used for human and veterinary purposes, thus the representation of “embryo” may require reengineering as well. The absence of “unaccompanied” adjectival forms of anatomical locations and systems likely contributed to a large number of the partial mapping problems.

In contrast to SNOMED CT, SNOMED 98 in the current UMLS version contains adjectives mapped to the anatomical structure for corneal, skeletal, cellular, etc. In SNOMED CT, these adjectival forms are “accompanied” of the qualifier “structure” or “system structure” or “entire” as in “skeletal system”, “skeletal system structure” or “entire skeleton”. With additional semantic information in the phenotype terminology (e.g., anatomical location, or system), one could easily pre-process and extend terms with this contextual information before submitting them to Norm. Some redundancy can be solved by enriching SNOMED CT with a complete network of relationship: “the entire central nervous system” does not have a partonomy relationship with the “entire nervous system” which led to an overlap of mapping. More specifically for phenotypes of model organisms and genetics, the following concepts are incompletely conceptualized in SNOMED: “normal embryogenesis”, “tumor resistance”, “tumor sensitivity”, or “maternal effect”.

It is expected that a careful modeling of semantic criteria could further improve the accuracy of the present methods but may require machine learning approaches to avoid overtraining. For example, to further discriminate between completely and incompletely mapped concepts, a phenotype should have an anatomical local coded or explicitly mapped from the relationships of its coded concept. Context and scale from the source terminology can be processed as additional semantic criteria: phenotypes from the yeast should map to cellular and smaller SNOMED concepts, etc.

### EXAMPLE 2

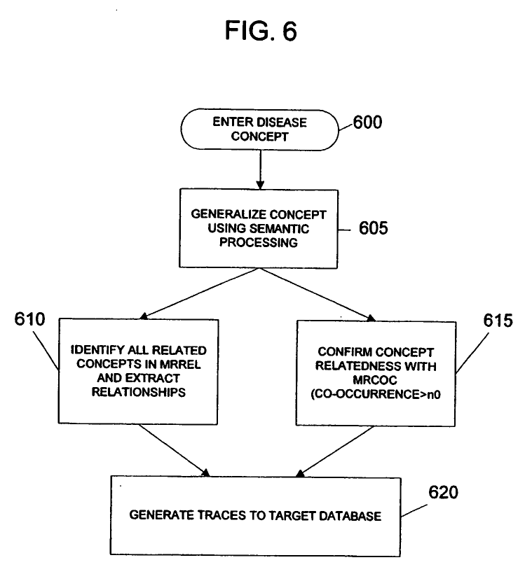

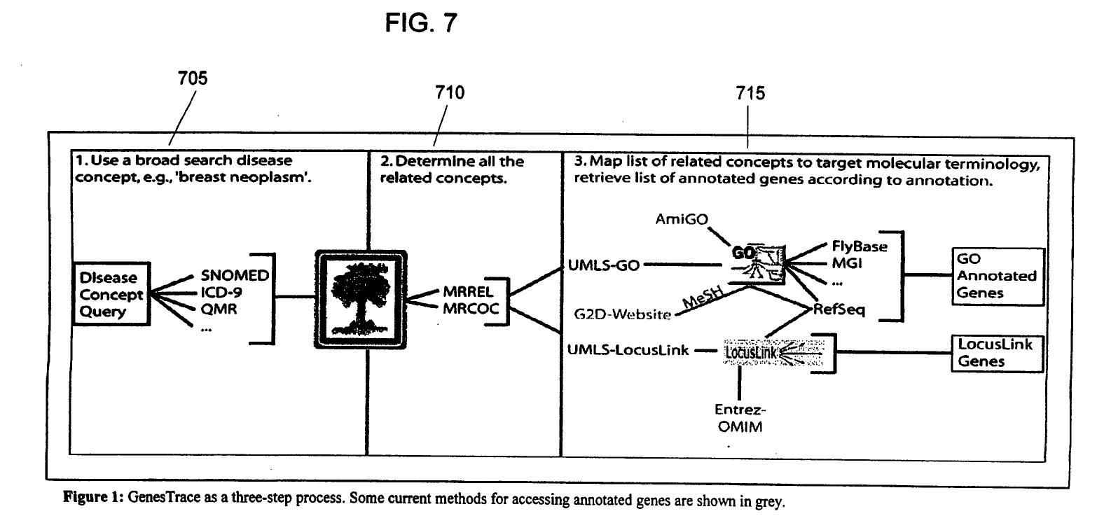

The following working example illustrates the successful application of the present methods, referred to herein as the Genes Trace Method. This example uses concepts in the UMLS to find putative genes in one database that are related to a particular disease based on clinical data in a second database. Additionally, the method uses links that span from clinical knowledge to basic molecular biological levels of knowledge in the source terminologies of the UMLS. As illustrated below, leveraging the knowledge that can be inferred from annotation of gene products and the etiology of a disease, one can discover links between diseases and particular genes. A simplified flow diagram of the Genes Trace Method is set forth in FIG. 6 and a pictorial flow diagram of this method is illustrated in FIG. 7. By reference to FIGS. 6 and 7, it can be appreciated that in this example UMLS is being used as a mediating database between clinical databases, such as SNOMED, ICD-9 and QMR and genomic databases such as GO to develop an amalgam database in accordance with the present invention.

### Material and Methods of Example 2

The GenesTrace method is an application of the present invention which reveals relationships (traces) between a disease and a gene according to the following three-step process:
(i) enter a disease that exists in the UMLS as a concept;
(ii) determine the relationships between a UMLS disease and other UMLS concepts using both the symbolic relationships (hierarchical and associative) and the statistical relationships (co-occurrence information); and
(iii) identify Putative Genes. The related concepts are used to map them to a clinical terminology then to a biological terminology, such as Gene Ontology, and then use the terminology to determine the list of putative genes through links to valuable knowledge contained in biological databases (e.g., FlyBase, WormBase, MGI, etc.). An overall schematic of the GenesTrace is shown in FIG. 7. Each step of the method is discussed in detail below.

Step 705: Identify a Disease (UMLS Disease Query).

GenesTrace is designed to operate with any disease concept, that is coded by the UMLS. In order to ensure semantic compatibility, a list of disease concepts is established in the UMLS. As test cases for the present methods, two disease concepts were selected: breast cancer using CUI C0006149, “breast neoplasms”, and Alzheimer's disease, CUI C002395. A list of diseases was also compiled that linked the diseases to OMIM in MRSO, and identified their corresponding CUI in the UMLS. The disease concepts were then considered candidates for performing a GenesTrace operation. More generally, as illustrated in FIG. 6, a disease concept is entered (step 600) and then subjected to semantic processing to generalize or expand the disease concept (step 605).

Step 710: Extract Relationships to Concepts (Relate Concepts through MRREL & MRCOC)

For each of the disease concepts of interest, all directly related concepts were obtained from the UMLS Metathesaurus Relation (MRREL) (step 610) and Co-Occurrence (MRCOC) (step 615) files. MRREL provides a list of concepts and their semantic relations to other concepts in the Metathesaurus. For example, “breast neoplasms” (C0006149) is a parent of “malignant neoplasm of the breast” (C0006142). MRCOC provides information about the co-occurrence of concepts, in a large part from published literature. For example, “breast neoplasms” (C0006149) co-occurs 55 times with “aneuploidy” (C0002938) in MEDLINE®.

Related concepts were found by searching for concepts that are related as found by MRREL (step 610). In addition, MRCOC was used to determine the co-occurring concepts (step 615). In order to improve specificity and to reduce the number of potentially erroneous associations, a threshold was set that each concept in the final list co-occurred a minimum of five times. In this manner, lists of associated concepts were generated that could be used in the next, and final, step of the GenesTrace method.

Step 715: Identify Putative Genes (Disease Trace)

The study described herein used UMLS 2003AA. Experimental mappings of UMLS to GO were used to perform the traces. From the list of associated concepts in UMLS, mappings of the concepts represented in GO were obtained via two methods. First, the GO terms that matched the retrieved CUIs were obtained. Next, the gene products represented in GO that corresponded to the retrieved CUIs were obtained. These mappings were based on automated and experimental information mapping between UMLS concepts and either GO terms or LocusLink entries.

The GO associations databases (available at the GO website) were accessed and the gene products associated with each mapped GO accession number were retrieved, as well as those directly represented in the UMLS, in each of the traces. It was then determined how many genes were retrieved for each trace. It was also determined how many traces were actually possible for each OMIM disease. For all associations, the searches were limited to those traces supported by the highest evidence levels (“Inferred from direct assay”, and “Traceable author statement”).

For Alzheimer's Disease and Breast Cancer, the searches were limited to four species databases (Fly, Mouse, Worm, Yeast) and to the highest evidence levels supporting the associations. Of note, the gene product table used contained no direct references to the Human Genome; therefore, a search was not done for any specifically human genes or gene products.

From this list, the products were sorted by symbol, name, and accession number. The resulting set of genes was then searched for relevance to the disease that was used for the GenesTrace. The lists were specifically searched for the genes that have well established and specific relations to the queried diseases (i.e., for breast neoplasm, BRCA1; for Alzheimer's, amyloid beta).

As an internal test that confirms the contribution of multiple databases to the traces, the CUIs for genes and proteins were eliminated from the list of related UMLS-CUIs that contained the search gene (e.g., for breast cancer the CUIs associated with “BRCA genes” were removed). The resulting set of genes was then searched again for known molecular and clinical relationships.

In order to perform the GenesTrace, scripts were written in Perl 5.0. The GO::AppHandle module was used for a number of scripts, as provided by the GO Perl AP12. The scripts were executed on a Solaris server (Sun Fire V880 Server with two UltraSPARC®III processors @900 MHz). Current version of GO and UMLS were used for the qualitative examples. A 2002 version of the UMLS was used for both establishing a list of the diseases from the UMLS and for the mappings to GO.

### Results for Example 2

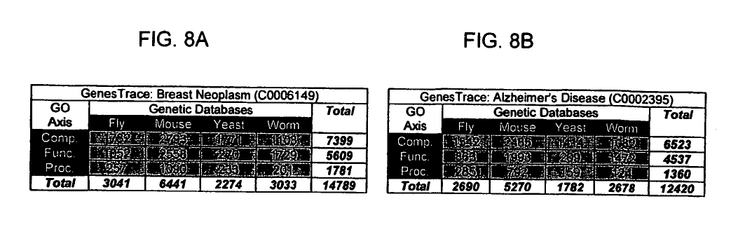

For each disease trace, the putative genes were determined in an average time of ten seconds. Example results are shown as aggregate data, based on types of genes found, in the tables of FIGS. 8A and 8B.

Traceable Diseases

Over 200,000 possible disease concepts on which traces could be performed were found, based on the search on UMLS concepts that were descendants of the UMLS concept for “disease” (C0012634). Additionally, 240 OMIM diseases that had corresponding CUIs on which a trace could be performed were identified.

Quantitative Evaluation

For the 240 OMIM diseases, 160 were identified with corresponding genes in OMIM's genemap; of these, 48 had traceable gene products. In each trace, additional concepts in MRREL and MRCOC were identified that then corresponded with GO annotations, as per the putative mappings between the terminologies. Of these, GenesTrace was able to perform a successful trace of GO annotated genes for 15 disease concepts.

Breast Cancer

The paths between the UMLS concept “breast neoplasms” and gene products in the GO database constitute traces. 220 concepts related to breast cancer were discovered from MRREL, and an additional 1,909 other concepts from MRCOC. Within MRREL, there were nine different types of relationships, with the most frequent being a “SIB” relationship (328 entries). Mapping these related UMLS concepts to GO led to 168 distinct GO terms, of which 126 were found in the molecular function axis, 25 in the biological process axis, and 17 in the cellular component axis.

In the GO database, the 168 GO terms were associated—as annotations—to 14,955 entries, representing 10,532 molecular products. When organized according to species 3048/4439 (38%), 6441/12673 (51%), 2274/7272 (31%), and 3033/6909 (44%) of the genes annotated in the fly, mouse, yeast, and worm respectively were recovered.

The specific details of the breast cancer trace was further explored. In the first step of the trace, the method obtained the UMLS concept “nucleus” (C0007610). In the second step, the concept was mapped to the GO term for “nucleus” (accession number 5634). Finally, in the last step of the GenesTrace, gene products annotated with this GO term were identified from the association tables. The murine form of BRCA1 was in this list. Similarly, BRCA1 was also traceable via the concept “cytoplasm” (5737). It was possible to obtain these traces to the BRCA1 gene product whether or not the concept list (as derived in the first step) contained the concept “BRCA genes.”

Alzheimer's Disease (AD)

225 concepts related to AD in MRREL were found, with an additional 953 concepts from MRCOC. There were 11 different types of links within MRREL, again with the most frequent being SIB (251 entries). Of the 106 GO terms obtained, 67 were from the molecular function axis, 21 from the biological process axis, and 18 were from the cellular component access.

The subsequent search of the GO database retrieved 12,780 entries, representing 9,526 unique gene products. When organized according to species it was found that 2690/4439 (34%), 5270/12673 (42%), 1792/7272 (25%), and 2678/6909 (39%) of the genes annotated in the fly, mouse, yeast, and worm were recovered, respectively. The murine form of Amyloid-Beta Protein was also present in this result set.

In each of the traces performed, genes that would be of interest were successfully identified. The incompleteness of possible traces may reflect the partial level of GO annotation for the OMIM diseases. The OMIM system contains a large number of annotations that are not contained in GO. Indeed, it was found that of the 424 genes associated from genemap with OMIM diseases, only 206 (49%) were actually annotated using GO. However, in each trace that was performed, genes were found that were traced that were to be expected for a given disease. Therefore, the results demonstrate the ability to retrieve genes relating to OMIM diseases that have been adequately annotated using GO.

The GenesTraces for Alzheimer's Disease and Breast Cancer retrieved approximately 10,000 gene products. This number is only a small fraction (˜0.8%) of the total number of total annotated gene entries (˜1.3 Million) in the GO associated databases. The results were organized based on the different GO axes (molecular function, cellular component, and biological process). Based on this organization, it was found that most of the items retrieved were annotated along the Cellular Component Hierarchy. It can be posited that this is reflective of the limitation of how genes are presently being annotated using GO. Thus, it is easier to be certain of the cellular component that a gene product can be found; however, it is far more difficult to establish the molecular function or process for of a gene product and subsequently annotate them using GO.

The GO project was originally conducted with the goal of providing a controlled vocabulary for the annotation of gene products in the fruit-fly, mouse, and yeast projects. However, because most of the genes that are contained in OMIM are of human origin, the lack of GO annotations impacts the ability to retrieve them. However, it is important to point out that there are other relevant knowledge bases that can be mined. Specifically, one can perform a GenesTrace to LocusLink. This would be particularly relevant, in order to obtain Human gene products. By performing disease traces to LocusLink, one can retrieve RefSeq annotated sequences, which are known genes for the human genome.

Additionally, items that had limited GO annotations provide another source of noise (e.g., BRCA1 in Alzheimer's Disease). The problem of retrieving noisy genes is not entirely unique to GenesTrace, as other previously existing methods for linking disease to genes also retrieve a large number of genes that are housekeeping genes. However, it is believed that if more detailed GO annotations were performed, then the GenesTrace method would retrieve less misleading genes.

The GenesTrace method is dependent on semantic links that can be found based on the query disease concept. Therefore, it is important to emphasize that the closest broad relevant disease concept is used for the GenesTrace method. The use of narrower disease concepts may reduce the sensitivity of the traces. For example, when an attempt was made to use “breast cancer” (C0006142), a narrower term than “breast neoplasm,” (C0006149) it was discovered that no related GO terms were retrieved. Conversely, traces that included all the child concepts of C0006149 returned the same set of gene products as one using only the broader CUI. This indicates that the GenesTrace method is dependent on the number of rich linkages that can be exploited from the UMLS. However, adding narrower concepts, which generally are linked to clinical information that is not present in GO, does not necessarily add value to the results of traces. Hence, these results suggest that to optimize precision and recall of GenesTrace, one should probably use the closest broad relevant disease concept to conduct disease traces.

The GenesTrace method described herein is able to create relevant links between clinical knowledge and molecular knowledge. These likely can be entries in an amalgamated database.

As more biomedical scientists adequately annotate gene products with GO, the GenesTrace method will be a valuable method to retrieve genes that may lead to further understanding of the etiology of disease. Through using standardized terminologies, and correlating them with the clinical descriptions with biological processes, one can quickly see the marriage between the biological and medical sciences.

### EXAMPLE 3

In this example, SNOMED CT and the Human Disease Genes (HDG) database are linked to one another using UMLS and OMIM as mediating databases.

Databases to be Related:

SNOMED-CT [8] is a comprehensive concept-based health care terminology. The version released in July 2002 was used. This version of SNOMED-CT contains 333,325 concepts. SNOMED-CT contains a cross-index with the older version of SNOMED 3.5 which contains about half as many concepts. For each SNOMED concept, there is one concept term and there may be several synonym terms associated to the concept as well.

HDG has been manually compiled and published in the journal Nature to classify disease genes and their related diseases. Each of the 921 disease gene records of HDG is also mapped to an OMIM unique identifier (concept). In addition, HDG contains at least one disease name (terms) for each of the distinct disease gene records.

### Intermediating Terminologies for Example 3

As discussed above, OMIM is a catalog of human genes and genetic disorders. OMIM focuses primarily on inherited and heritable genetic diseases. The 2002 version of OMIM contains 14280 entries, including 8733 human gene loci. Each OMIM unique concept identifier contains two distinct fields in which disease terms are found: the “Title”, and the “Disorder”. The “Title term” field contains gene products and diseases with no semantic class to distinguish between the terms, while all disorder terms can be considered as one semantic class subsumed by “diseases.”

The 2002AB version of the UMLS, created and maintained by the National Library of Medicine, was used for this example. This version of UMLS consists of 871,584 unique concepts over 60 diverse terminologies. For each UMLS concept, there is one concept term and there may be several synonym terms associated to the concept as well. Disease terms of UMLS are grouped together as a semantic class. The UMLS Metathesaurus includes 208,454 concepts linked to SNOMED International 3.5 (1998 version) and 250 concepts linked directly to terms of OMIM (1993 version).

### Methods of Example 3

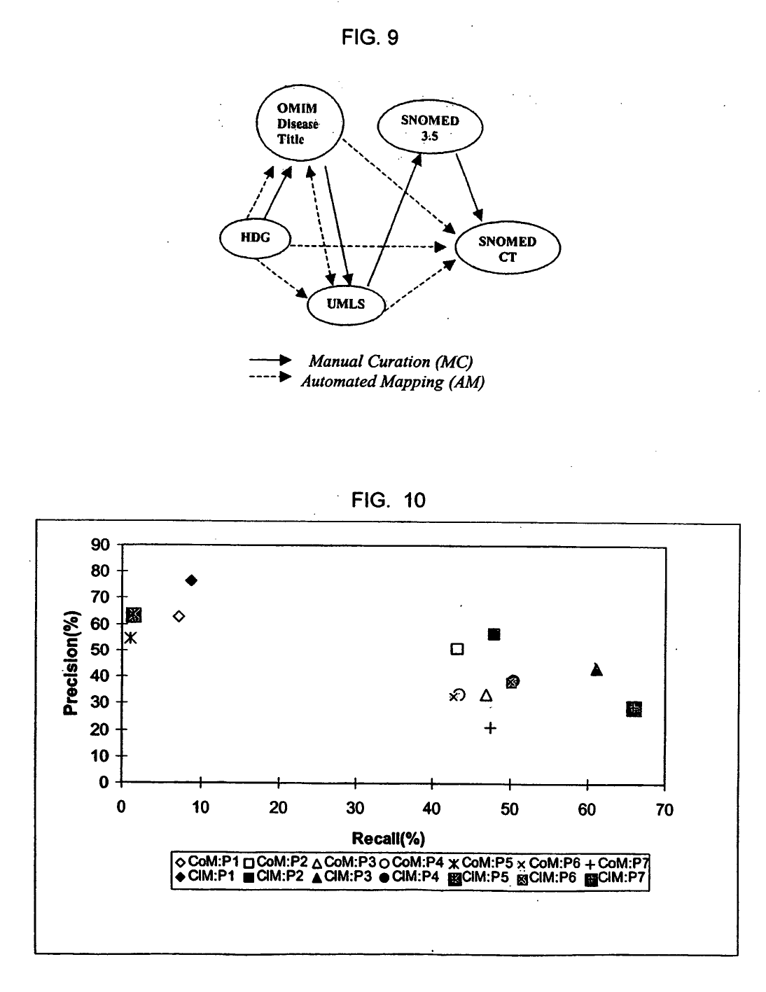

Networks between databases can be manually curated (e.g., via shared cross-indexes) or automated (e.g., via lexical or semantic methods). When concept mapping occurs at the stage of indexing or cataloging and is conducted manually, this practice is referred to as “manual curation” (MC). In contrast, “automated mapping” (AM) will refer to the mapping of terms associated to the concepts of two terminologies with no manual supervision nor curation. FIG. 9 illustrates a network of terminological relationships between the databases to be related (SNOMED-CT, HDG) and the intermediating terminologies (OMIM, UMLS, SNOMED 3.5). The arrows in the figure show the available types of mapping (MC, AM). Solid lines in FIG. 9 represent MC whereas dashed lines represent AM.

Automated mapping was conducted using previously published methods that include lexical and semantic constraints as described below. Several properties of the terminological network have been explored including types of mapping and number of intermediaries. Distinct mapping strategies generate different types of terminological paths that we categorized as follows: (a) purely MC-based (table 1, P1), (b) purely AM-based (table 1, P2-7). Combined pre-post-coordination methods were beyond the scope of the current study. Similarly the number of intermediating terminologies investigated were: (a) zero (Table 1², P2), (b) one (Table 1², P3, P4, P5), (b) two (table 1², P6, P7), and (b) three (table 1², P1).
2 http://www.godatabase.org/dev/database

Manual Curation. As a Metathesaurus, UMLS has a broad inclusion of composite source terminologies that can be exploited for pre-coordination. For example 162 distinct UMLS concepts can be mapped to both OMIM 1993 and SNOMED 1998 terminologies. UMLS contains cross-indexes (table MRSO of UMLS) to the 1993 version of OMIM and the 1998 of SNOMED. As shown in FIG. 9, only one path via MC connects SNOMED-CT to HDG (table 1², P1).
2 http://www.godatabase.org/dev/database

Automated Mapping was performed using two known lexical methods: exact matching (EM) and the National Library of medicine Normalization (Norm) matching. Semantic constraints take advantage of prior categorization of both the original terms and the target concepts to exclude semantically irrelevant mappings.

### Evaluation of Terminological Pathways in Example 3

First Quantitative evaluation: Accuracy of Concepts Maps (A Co).

The accuracy of each of the mapping methods was measured based on terminological paths using precision and recall in the resulting HDG-SNOMED concept pairs. As lexico-semantic methods evaluate term-pairs, they are further transformed in a concept-oriented view since multiple terms can be associated in one concept in SNOMED-CT and in HDG. Recall was calculated as the ratio of the number of distinct HDG-SNOMED concept pairs that were identified by the mapping method that match HDG-SNOMED concept pairs in the Gold Standard (GS), divided by the total number of pairs in the GS, TP/(TP+FN). Precision was measured as the ratio of the number of distinct HDG-SNOMED concept pairs returned by the mapping method that match HDG-SNOMED concept pairs in the GS, divided by the total number of putative HDG-SNOMED concept pairs found by the mapping method, TP/(TP+FP).

Second Quantitative evaluation: Accuracy of Class-Based Map (A CI). Due to the high level of granularity of the SNOMED terminology, an additional accuracy score was calculated for the class of a concept. For the purpose of this score, the mapping of a HDG concept to an ancestor or a descendant of the associated SNOMED concept in the GS was considered a “True-positive” class-based mapping. Recall and precision are calculated on this basis.

Qualitative evaluation. Intermediating terminological pathway terms and concepts are not evaluated in the accuracy score based on HDG-SNOMED concept pairs. Therefore, the full pathway maps of the manual curation pathway (P1) were manually analyzed and the pathway maps of the automated mapping techniques were sampled.

A Gold standard (GS) linking HDG to SNOMED has been produced by the agreement of two experienced knowledge engineers working independently at mapping HDG concepts to SNOMED concepts. Each HDG concept was mapped by two knowledge engineers. Agreement was observed for 514 distinct HDG records.

### Application and Scripts in Example 3

All the application and scripts used to implement the methods are written in C++, Java, Perl and SQL. Most of applications are run on a Sun machine running the SunOS5.8 operating system.

TABLE 12
Linking Paths derived from the network of FIG. 9

| Path | Intermediating | |
|---|---|---|
| name | terminologies (#) | Complete Path |
| P1 | 3 | HDG = OMIM = UMLS = SNOMED-CT |
| P2 | 0 | HDG → SNOMED |
| P3 | 1 | HDG → UMLS → SNOMED |
| P4 | 1 | HDG → OMIM (Disease terms) → SNOMED |
| P5 | 1 | HDG → OMIM (Title terms) → SNOMED |
| P6 | 2 | HDG → UMLS → OMIM → SNOMED |
| P7 | 2 | HDG → OMIM → UMLS → SNOMED |

A = B Manual Curation/Mapping of terms via a common index between databases A and B.
A→B Automated Mapping/lexico-semantic mapping of terms between databases A and B.

TABLE 13
Qualitative evaluation of the P1 pathway from the terminological network of Example 3

| | | SNOMED Disease in | SNOMED Disease in |
|---|---|---|---|
| Number | HDG Disease | automating matching | Gold Standard |
| 1 | Galactosemia (230400) | Galactosemia (disorder) | Galactosemia (disorder) |
| | | [Ambiguous] (38177000) | (190745006) |
| 2 | Pseudohypoparathyroid- | ‘Pseudohypoparathyroidism | Pseudohypoparathyroidism |
| | ism, | (disorder) (58976002) | type I A (disorder) |
| | type Ia (103580) | | (58833000) |
| 3 | Meningioma, NF2- | Neurofibromatosis, type 2 | Intracranial meningioma |
| | related, sporadic, | (disorder) | (disorder) |
| | Schwannoma, sporadic | (92503002) | (302820008) |
| | (101000) | | |
| 4 | Apert syndrome | Apert's syndrome (disorder) | Acrocephalosyndactyly |
| | (101200) | (63661009) | (disorder) (268262006) |

### Results for Example 3

Concept-based Quantitative Evaluation. The accuracy of the present terminological mapping using the network are summarized in the graph of precision version recall in FIG. 10. As described in FIG. 9, manual curation utilizes the internal mapping of OMIM and SNOMED 3.5 in UMLS, which simulates the linking of HDG and SNOMED via a common and pre-existing index. This sets the baseline for the performance of paths derived from the network. The present analysis shows that the manually curated pathway provided a better precision (62.7% and 76.2% for CoM and CIM, respectively), and poorer recall (7.1% for CoM, 8.7% for CIM) than the automated mapping. The direct mapping of HDG to SNOMED (P2) provided an intermediate accuracy as compared to other techniques (42.9% for recall and 50% for precision using CoM). Paths involving one level of intermediating terminologies either give higher recall (such as P3 and P4) while sacrificing a degree of precision, or vice versa (P5), as compared to the direct path (P2). Both paths containing two levels of intermediating terminologies (P6 and P7) give higher recall but lower precision, compared to the direct path.

Class-based Quantitative Evaluation. The ancestor-descendent relationships in SNOMED-CT allow a user to explore the class-based mapping when an exact matching pair is not available from source to target databases. As is seen in FIG. 10, all pathways show increased recall and precision with the class-based accuracy, some showing better improvements than other (e.g., P5's precision increases from 54.5% to 63.6%, P7's recall increase from 47.47% to 65.75%).

Qualitative Evaluation. The mismatched (according to the GS) HDG-SNOMED-CT pairs of concepts were manually reviewed in the MC set P1. In addition, a subset of the mismatched pairs of other sets was also manually curated. Table 13 provides examples of these mismatches taken from P1. The mismatches can be categorized into four classes: (i) retired concepts in SNOMED. 36% of mismatches in P1 are attributable to concept in SNOMED 3.5 (UMLS that have been retired in SNOMED-CT) (e.g., #1, an ambiguous concept (38177000) in SNOMED 3.5 has been replaced in SNOMED-CT with an new concept 190745006, which is not reflected in UMLS); (ii) Class-based indexing in MC (e.g., Table 13, # 2: the network finds the ancestor of the matching concept in SNOMED-CT), 42% of mismatches fall in this category for CoM, and are considered matched by the CIM; (iii) Ambiguity in HDG. More than one concepts share the same code in the database (e.g., Table 13, #3, two disease sharing the same MIM number in HDG), 12% of mismatches in P1 are ambiguous; and (iv) Redundancy in SNOMED. More than one concept shares the same meaning in a terminology and are represented by multiple codes (e.g., table 2, #4, “Apert syndrome” has been modeled in two different concepts in SNOMED-CT). About 10% of mismatches in P1 are redundant.

It was found in this example that the manual curation provided high precision and low recall. This may be attributable to the rapidly evolving OMIM and SNOMED-CT terminologies, as each terminology has more than doubled since their inclusion in UMLS. In this example, multiple pathways did not generally lead to higher precision, perhaps due to an increased noise for each successive automated map. While the precision remained high in the manually curated map regardless of its highest number of intermediating terminologies. Interestingly, one terminological pathway (P5) provides a precision approaching that of the manual curation.

Curiously, P4 and P5 use the same intermediary pathway but different terminological fields. P4 uses a field containing uniquely diseases and disorders, while P5 uses the term field also containing gene products and surprisingly P5 outperforms P4 while no semantic constraints could be fabricated over P5 since OMIM does not have semantic classes. One explanation could be that the “Title” field of OMIM is more often explored than the “disease” field and therefore more “normalized” due to increased feedback from the community of OMIM users.

It has also been demonstrated that terminological pathways are non-commutative methods. This was expected and shown by the same terminologies used in distinct combinations in path P6 and P7.

Multiple strategies with automated direct mapping methods can be used to increase accuracy between two terminologies. Using an incremental hybrid mapping approach combined with terminological pathways (e.g., P1, P5, P6), increases the recall to 48.1% and the accuracy to 53%, results comparable to P2. The class-based evaluation measures the mapping of one terminology to a class of the second. Every mapping technique from MC, to AM and regardless of its number of intermediating terminologies was improved.

It is believed that the mapping of P1 could be improved by translating retired SNOMED 3.5 concepts in current ones using are relationship from SNOMED-CT pointing retired concepts to their current equivalent (when available). This would further increase the precision of P1.

With the rapid development of information in genomics research and the large amounts of available clinical information relating to disease, methods are required for integrating such information in ways that can lead to identification of relationships between terms of different databases. Through discovery of such relationships, one can associate specific genomic information with specific diseases.

Discovery of such associations can provide information relating to the genetic basis of diseases and can provide useful information about approaches to treatment of such diseases.

Thus, the present invention provides methods and compositions for integrating information derived from different databases having disparate informatics terminologies. In particular, the invention is designed to integrate information from genetic databases, such as GO or OMIM, with information from clinical databases such as UMLS. Linking of genetic information at the nucleic acid and protein level to clinical data, such as symptoms and treatment of diseases, provides a means for mapping relationships between genetic phenotypes and clinical phenotypes.

Although the present invention has been described in connection with specific exemplary embodiments, it should be understood that various changes, substitutions and alterations can be made to the disclosed embodiments without departing from the spirit and scope of the invention as set forth in the appended claims.

What is claimed is:

1. A method for creating an amalgamated bioinformatics database from at least a first database and a second database comprising the steps of:
identifying a first field from the records of the first database;
identifying a second field from the records of the second database, the second field having data related to the first field;
identifying a first set of concepts by traversing a mediating database using terms associated with the first field;
identifying a second set of concepts by traversing the mediating database using terms associated with the second field;
wherein at least one of the steps of identifying the first set of concepts or identifying the second set of concepts is performed using non-trivial terminological mapping;
determining a set of related concepts in the first set of concepts and the second set of concepts; and
generating a record in the amalgamated bioinformatics database comprising data from records of the first database, data from records of the second database and at least a portion of the related concepts from the mediating database.

2. The method of claim 1, wherein at least one of the first database and second database includes clinical data associated with at least one disease.

3. The method of claim 1, wherein at least one of the first database and second database includes genomic data associated with at least one disease.

4. The method of claim 1, wherein one of the first and second database includes clinical data associated with at least one disease, the other of the first and second database includes genomic data associated with the least one disease and wherein the related concepts associate said clinical data and said genomic data.

5. The method of claim 1 wherein the step of terminological mapping includes at least one term expansion operation.

6. The method of claim 1 wherein the step of terminological mapping includes at least one term normalization operation.

7. The method of claim 1 wherein the step of terminological mapping includes at least one term expansion operation and at least one term normalization operation.

8. The method of claim 1 wherein the step of terminological mapping includes a natural language processing operation.

9. The method of claim 1 wherein the step of terminological mapping includes a semantic processing operation for part of speech identification.

10. The method of claim 1, wherein at least one of the first database and second database is a structured database.

11. The method of claim 1, wherein at least one of the first database and second database is a semi-structured database.

12. The method of claim 1, wherein at least one of the first database and second database is an unstructured database.

13. A method for creating an amalgamated bioinformatics database from at least a first database and a second database comprising the steps of:
identifying a first field from the records of the first database;
identifying a second field from the records of the second database, the second field having data related to the first field;
identifying a first set of concepts by traversing a mediating database using terms associated with the first field;
identifying a second set of concepts by traversing the mediating database using terms associated with the second field;
determining a set of related concepts in the first set of concepts and the second set of concepts;
for least a portion of the related concepts, inheriting relationships of the related concepts from the mediating database; and
generating a record in the amalgamated bioinformatics database comprising data from records of the first database, data from records of the second database and the related concepts and inherited relationships from the mediating database.

14. The method of claim 13, wherein at least one of the first database and second database includes clinical data associated with at least one disease.

15. The method of claim 13, wherein at least one of the first database and second database includes genomic data associated with at least one disease.

16. The method of claim 13, wherein one of the first and second database includes clinical data associated with at least one disease, the other of the first and second database includes genomic data associated with the least one disease and wherein the related concepts associate said clinical data and said genomic data.

17. The method of claim 13, wherein at least one of the first database and second database is a structured database.

18. The method of claim 13, wherein at least one of the first database and second database is a semi-structured database.

19. The method of claim 13, wherein at least one of the first database and second database is an unstructured database.

20. The method of claim 13, wherein the inherited relationships include an “is a” relationship.

21. The method of claim 13, wherein the inherited relationships include a partonomy relationship.

22. The method of claim 13, wherein the inherited relationships includes at least one ancestral relationship.

23. The method of claim 13, wherein the inherited relationships includes at least one relationship selected from the group consisting of an “is a”, a partonomy and an ancestral relationship.

24. A method for creating an amalgamated bioinformatics database from at least a first database and a second database comprising the steps of:
identifying a first field from the records of the first database;
identifying a second field from the records of the second database, the second field having data related to the first field;
identifying a first set of concepts by traversing a mediating database using terms associated with the first field;
identifying a second set of concepts by traversing the mediating database using terms associated with the second field;
wherein at least one of the steps of identifying the first set of concepts or identifying the second set of concepts is performed using terminological mapping;
determining a set of related concepts in the first set of concepts and the second set of concepts;
for least a portion of the related concepts, inheriting relationships of the related concepts from the mediating database; and
generating a record in the amalgamated bioinformatics database comprising data from the records of the first database, data from the records of the second database and the related concepts and inherited relationships from the mediating database.

25. The method of claim 24, wherein at least one of the first database and second database includes clinical data associated with at least one disease.

26. The method of claim 24, wherein at least one of the first database and second database includes genomic data associated with at least one disease.

27. The method of claim 24, wherein one of the first and second database includes clinical data associated with at least one disease, the other of the first and second database includes genomic data associated with the least one disease and wherein the related concepts associate said clinical data and said genomic data.

28. The method of claim 24 wherein the step of terminological mapping includes at least one term expansion operation.

29. The method of claim 24 wherein the step of terminological mapping includes at least one term normalization operation.

30. The method of claim 24 wherein the step of terminological mapping includes at least one term expansion operation and at least one term normalization operation.

31. The method of claim 24 wherein the step of terminological mapping includes a natural language processing operation.

32. The method of claim 24 wherein the step of terminological mapping includes a semantic processing operation for part of speech identification.

33. The method of claim 24, wherein the inherited relationships include an “is a” relationship.

34. The method of claim 24, wherein the inherited relationships include a partonomy relationship.

35. The method of claim 24, wherein the inherited relationships includes at least one ancestral relationship.

36. The method of claim 24, wherein the inherited relationships includes at least one relationship selected from the group consisting of an “is a”, a partonomy and an ancestral relationship.

37. The method of claim 24, wherein at least one of the first database and second database is a structured database.

38. The method of claim 24, wherein at least one of the first database and second database is a semi-structured database.

39. The method of claim 24, wherein at least one of the first database and second database is an unstructured database.

40. A method for creating a knowledge base of relationships between at least one biodata item that is a molecule and at least one other biodata item, comprising the steps of:
(a) using a first database storing at least one biodata item that is a molecule associated with at least one other biodata item, said other biodata item being contained in a first set;
(b) using a second database storing a second set of at least one biodata item and any information associated therewith, wherein the first set and the second set are not identical;
(c) using at least one non-trivial terminological mapping operation in connection with a mediating database for identifying an association between a biodata item of the first set with a biodata item of the second set,
(d) for each association identified in step (c), finding a relationship between the biodata item that is a molecule associated with the other biodata item of the first set of the association and the information associated with the biodata item of the second set of the association;
(e) storing each relationship found in step (d) in a knowledge base.

41. A method of integrating a first and second database which are interoperable heterogeneous databases without a common key,
wherein the first database contains a bioobject associated with a first record comprising a biodata item that is a molecule and a first correlating biodata item;
wherein the second database contains a bioobject associated with a second record comprising a second correlating biodata item and a unique biodata item, where there is no equivalent to the unique biodata item in the first database;
comprising the steps of:
(a) using a mediating database to link the first correlating biodata item in the first database to the second correlating biodata item in the second data base using at least one non-trivial terminological mapping operation;
(b) creating relationships between the biodata items in the first record and the second record, thereby producing an amalgamated third record comprising the biodata item which is the molecule and a plurality of biodata items, including the unique biodata item; and
(c) storing the amalgamated record in an amalgamated database.

42. A method of integrating a first and second database which are interoperable heterogeneous databases without a common key,
wherein the first database contains a bioobject associated with a first record comprising a biodata item that is a molecule and a first correlating biodata item;
wherein the second database contains a bioobject associated with a second record comprising a second correlating biodata item and a unique biodata item, where there is no equivalent to the unique biodata item in the first database;
comprising the steps of:
(a) transforming at least one of the databases into a generic format;
(b) using at least one terminological mapping operation to a mediating database to link the first correlating biodata item in the first database to the second correlating biodata item in the second data base;
(c) creating relationships between the biodata items in the first record and the second record, thereby producing an amalgamated third record comprising the biodata item which is the molecule and a plurality of biodata items, including the unique biodata item; and
(d) storing the amalgamated record in an amalgamated database.

43. The method of claim 41 wherein one database is structured.

44. The method of claim 41 wherein one database is semi-structured.

45. The method of claim 41 wherein one database is a genomic database.

46. The method of claim 41 wherein one database is a genetic database.

47. The method of claim 41 wherein one database is a proteomic database.

48. The method of claim 41 wherein one database is a gene expression database.

49. The method of claim 41 wherein one database comprises a biodata item derived from a non-human organism.

50. The method of claim 41 wherein one of the first or second database is selected from the group consisting of a genomic database, a genetic database, a proteomic database, and a gene expression database and the other of the first or second database is selected from the group consisting of a preclinical database and a clinical database.

51. The method of claim 41 wherein the one of the first or second correlating biodata item is a disorder and the other of the first or second correlating biodata item is a disease.

52. The method of claim 50, wherein the first correlating biodata item is a disorder and the second correlating biodata item is a disease

53. The method of claim 50, wherein the unique biodata item is a clinical manifestation of a disease.

54. The method of claim 51, wherein the unique biodata item is a clinical manifestation of a disease.

55. The method of claim 52, wherein the unique biodata item is a clinical manifestation of a disease.

56. The method of claim 41 wherein the mediating database is generated using an automated network created from a source selected from the group consisting of related terminologies and databases using a method selected from the group consisting of exact index matching, norm, MMTX and a combination thereof.

57. An amalgamated database produced by the method of claim 1.

58. A method of performing a biomedical informatics analysis comprising
(a) querying the amalgamated database of claim 57 with a classification schema to transform the data into a phenotype/trait format; and
(b) exporting the data transformed in step (i) to a biomedical informatics software.

59. The method of claim 58, further comprising the step of performing a clustering analysis selected from the group consisting of self-organizing maps and hierarchical clustering.

60. The method of claim 59, comprising the further step of identifying a statistical correlation between a pair of bioobjects or biodata items.

61. The method of claim 60, wherein one bioobject or biodata item is a phenotypic trait and the other is a gene.

62. The method of claim 60, wherein one bioobject or biodata item is a phenotypic trait and the other is a protein.

63. A map of genomic DNA produced using an amalgamated database of claim 57, showing a genetic linkage between clinical manifestations of disease.

64. A method of identifying linkage between a phenotypic trait and a gene, comprising producing a map according to claim 63 and co-locating the phenotypic trait and the gene.
